(19) United States
(12) Patent Application Publication
(10) Pub. No.: US 2006/0215085 A1
(43) Pub. Date: Sep. 28, 2006

(54) Reflective and transflective liquid crystal display

(75) Inventors: Wen-Chun Wang, Taichung City (TW); Ming-Chang Yu, Taichung City (TW); Henta Kang, Taichung City (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/320,765

(22) Filed: Dec. 30, 2005

(30) Foreign Application Priority Data
Mar. 22, 2005 (TW) 094108696

(51) Int. Cl. G02F 1/1335

(52) U.S. Cl. 349/114

(57) ABSTRACT

A reflective and transflective liquid crystal display, a figure of bump structure is defined at a pixel electrode, and a reflective layer is formed around the peripheral at the top or bottom of the figure of bump structure to define the reflective zone and the transmissive zone of each single pixel. The upper electrode can contain the figure of slit or bump structure. By adjusting the relative positions of the figures of slit or bump structure between electrodes, the pre-tilt angles and tilting directions of liquid crystal molecules can be controlled, and a multi-domain division alignment is formed, and thus a multi-domain division, semi-transmissive, and wide view angle liquid crystal panel can be formed.

### FIELD OF THE INVETNION

The present invention is about a semi-transmissive, semi-reflective, wide view angle liquid crystal display and its main feature includes the formation of multi-domain division and built-in reflective function.

### BACKGROUND OF THE INVENITON

The most frequently criticized about earlier liquid crystal display (LCD) is the limited view-angle. Only within the range of ±45 degrees from the center of panel can present proper images. However the development and the increasingly diversified applications of large dimension panels, together with higher and higher demand for visual sensations, whether a liquid crystal display possesses the function of wide view angle is getting more and more important.

There are presently two major wide view angle techniques: one is an external mode and the other is a built-in mode (For example Multi-domain Vertical Alignment, MVA, and In-Plane Switching, IPS, etc.). In U.S. Pat. No. 6,380,996, entitled “Optical Compensatory Sheet and Liquid Crystal Display” disclosed that birefringence (Δn<0) transparent compensation films (As shown in FIG. 1.) are used to compensate for phase delay arise from TN liquid crystal(LC) cells (Δn>0) to realize the purpose of wide view angle. Although a wider view angle can be obtained by attaching a high precision diffusion film, it is fixed after all, and is not capable of compensating for all gray scale at all view angles. Therefore the gray scale inversion phenomenon commonly seen in TN mode liquid crystal display still exists.

In U.S. Pat. No. 6,661,488, entitled “Vertically-Aligned (VA) liquid crystal display device” disclosed that a technique was proposed where a ridge-shaped protrusion was used to render a pre-tilt angle on the liquid crystal (as shown in FIG. 2). The larger tip angle of bump the smaller of tilt on long axis of the molecule.

FIG. 3 shows a bi-domain MVA mode liquid crystal. When the voltage is OFF, the long axis of liquid crystal molecules is vertical to the display panel, only the liquid crystal molecules close to the bump electrode are slightly tilted, therefore the light can not transmit through the orthogonal of top and bottom polarizer. When the voltage is ON, the liquid crystal molecules near the bump rapidly rotate other liquid crystal molecules to an angle vertical to the surface of bump, that is, the long axis of liquid crystal molecules is tilted to the display panel, hence transmission is increased, and therefore modulation of light is realized. Since the states of neighboring liquid crystal molecules happened to be symmetrical in this bi-domain mode, the long axis of LC molecules points in opposite directions. The MVA mode realizes optical compensation through this difference in long axis orientations in liquid crystal molecules.

The actual visual effect is shown in FIG. 4. A medium grey scale is seen at B, and a medium grey scale is also seen at A and C as a result of a mixture of high grey scale and low grey scale. However, without optical compensation, the improvement of view angle is limited to the four directions (up, down, left and right) in MVA mode. The improvement is limited from other view angles. There may even be an inversion of grey scale on the display at a very large view angle from certain specific directions. The strength of electric field is not uniform because of its special electrode arrangement. Hence an incorrect grey scale display will occur if the strength of electric field is not high enough. Therefore a driving voltage of up to 13.5V is needed to accurately control the rotation of liquid crystal molecules. However, this requires additional power consumption.

In U.S. Pat. No. 5,598,285, entitled “Liquid crystal display device” disclosed that an IPS mode is used where thin stripes of alternative positive and negative electrodes are placed on a substrate as shown in FIG. 5. When the voltage is applied to the electrodes, the liquid crystal molecules which are originally parallel to the electrodes will rotate to the direction vertical to the electrodes. However, the long axes of liquid crystal molecules remain parallel to the substrate, controlling the magnitude of voltage will rotate the liquid crystal molecules to the desired angle. With a pair of appropriately arranged polarizers, transmission of the polarized light can be tailored to display various color levels. Instead of twisted nematic configuration, liquid crystal molecules are arranged so that the long axes always remain parallel to the substrate.

Unlike in other liquid crystal modes where the electrodes are on both sides of the substrate, all the electrodes are on the same side in IPS mode. Only in such a manner, a planar electric field can be constructed to incur lateral movements on liquid crystal molecules. When a voltage is applied to the electrodes, the liquid crystal molecules closer to the electrodes will gain higher momentum, and rapidly turn 90 degrees without difficulty. However the upper-layer liquid crystal molecules which are further away from the electrodes will not gain the same momentum, hence the movement is slower. Only by applying a higher driving voltage, liquid crystal molecules which are further away from the electrodes can gain sufficient momentum. Therefore IPS mode requires 15 volts which is higher than usual LCD. Since electrodes on the same plane lowers the aperture rate and the transmission of light. Thus the IPS mode requires more additional back lighting tubes.

### SUMMARY OF THE INVENTTION

To resolve the deficiencies stated above, the main purpose of the present invention is to control various tilt directions in liquid crystal molecules through fringe electric field effect in perpendicular direction, to incur a perpendicular alignment of multi-domain division. The pixel electrodes define transmissive zones and reflective zones, forming a wide view angle liquid crystal display with reflective effects.

The secondary purpose of the present invention is to propose a semi-reflective structure, forming a wide view angle liquid crystal display with reflective effects which possesses advantages of both reflective and transmissive LCDs. The effect of wide view angle, excellent clarity of image both indoors and outdoors, and lower power consumption can be achieved.

The structure of the present invention includes a first substrate on which a pixel electrode is located. A bump structure is defined on the pixel electrode using a photolithography processes. Then a reflective layer is formed at the top or bottom of the peripheral of the bump structure under the pixel electrode to define the reflective zone and tansmissive zone. A polarizing layer covers the pixel electrode and the reflective layer. An upper electrode and a polarizer are installed on the surface of a secondary substrate. The transmissive axis of polarizer is normal to the polarizing layer. The upper electrode also contains a slit or a bump structure figure. Adjusting the relative position of the slit/bump structure between electrodes provides the liquid crystal molecules with pre-tilt angles and a controlled direction of tilt, forming a multi-domain division alignment. Meanwhile, the reflective zone and the transmissive zone form a semi-transmissive, semi-reflective liquid crystal display device as stated in the present invention. Hence the liquid crystal display device in the present invention will achieve the effect of wide view angle, excellent clarity of image both indoors and outdoors, and lower power consumption at the same time.

### BRIFE DESCRIPTION OF THE DRAWINGS

FIG. 1 is the schematic diagram of a compensation film of attachment mode.

FIG. 2 is the schematic diagram of a built-in MVA mode liquid crystal.

FIG. 3 is the schematic diagram of a built-in bi-domain MVA mode liquid crystal.

FIG. 4 is the schematic diagram of the realistic visual effect of a built-in MVA mode liquid crystal.

FIG. 5 is the schematic diagram of a built-in IPS mode liquid crystal.

FIG. 6 is the first schematic diagram of the structure of liquid crystal display in the present invention.

FIG. 7 is the schematic top view diagram of pixels of liquid crystal display in the present invention.

FIGS. 8A˜8G are schematic top view diagrams of bump or slit on both electrodes.

FIGS. 9A˜9F are schematic diagrams of relative positions of bump or slit patterns on both electrodes.

FIG. 10 is the schematic diagram of the present invention before applying voltages.

FIG. 11 is the schematic diagram of the present invention when voltage is applied.

FIG. 12 is the second schematic diagram of the structure of liquid crystal display in the present invention.

FIG. 13 is the third schematic diagram of the structure of liquid crystal display in the present invention.

FIG. 14 is the fourth schematic diagram of the structure of liquid crystal display in the present invention.

FIG. 15 is the fifth schematic diagram of the structure of liquid crystal display in the present invention.

FIG. 16 is the sixth schematic diagram of the structure of liquid crystal display in the present invention.

FIG. 17 is the seventh schematic diagram of the structure of liquid crystal display in the present invention.

FIG. 18 is the eighth schematic diagram of the structure of liquid crystal display in the present invention.

FIG. 19 is the ninth schematic diagram of the structure of liquid crystal display in the present invention.

FIG. 20 is the tenth schematic diagram of the structure of liquid crystal display in the present invention.

FIG. 21 is the eleventh schematic diagram of the structure of liquid crystal display in the present invention.

FIG. 22 is the twelfth schematic diagram of the structure of liquid crystal display in the present invention.

FIG. 23 is the thirteenth schematic diagram of the structure of liquid crystal display in the present invention.

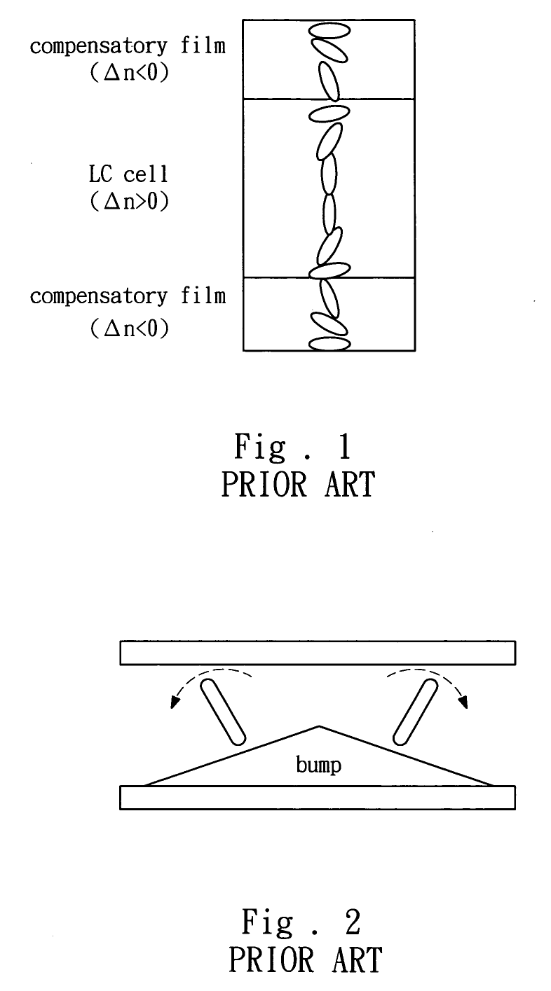

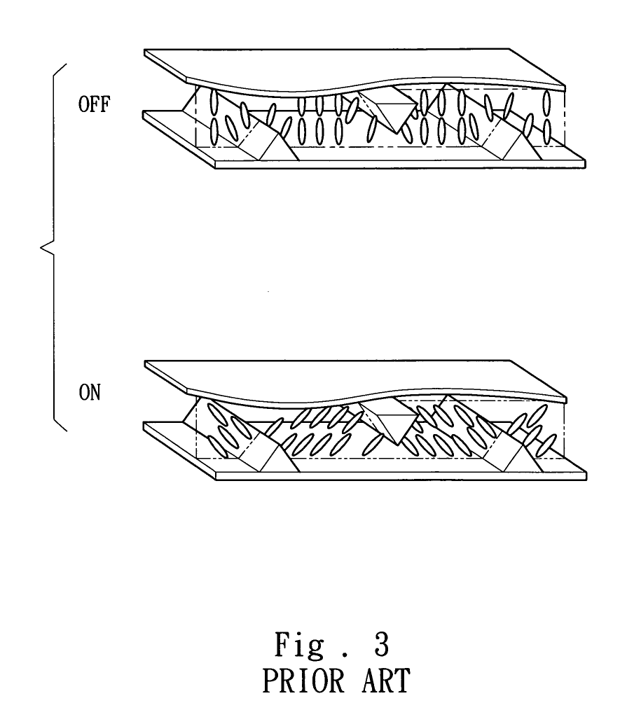

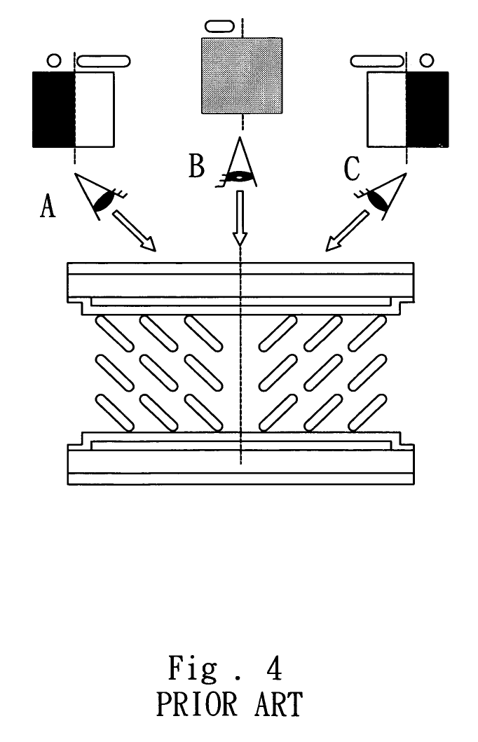

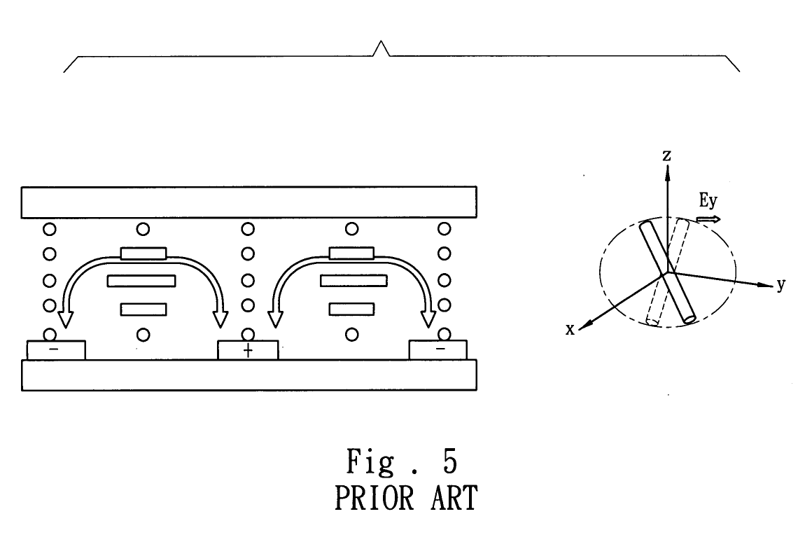

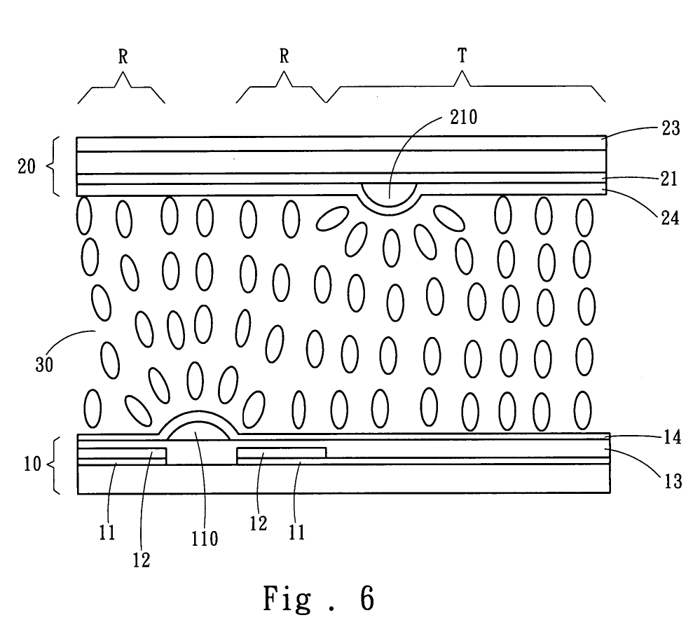

### DETAILED DESCRIPTION OF THE PREFERRED EMBODIMENTS

The detailed contents and techniques of the present invention are described with figures as follows.

Referring to FIG. 6, the first schematic diagram of the structure of liquid crystal display in the present invention, the structure contains a first substrate 10 with a thin film transistor, and a pixel electrode 11 is installed on the top of the first substrate 10. Then a reflective layer 12 is deposited to cover part of pixel electrode 11 to define a reflective zone R, and a transmisive zone T of the pixel. The reflective layer 12 is made of low resistance and high reflectivity metallic materials (such as Al, Ag, Mo, Cr, AlNd etc.). A polarizing layer 13 is then formed to cover the reflective layer 12 and the pixel electrode 11. A pattern of bump structure 110 is then defined on the surface of polarizing layer 13 using a photolithography processes. The pattern of bump structure 110 within each pixel contains at least one dot-like bump. Also, the reflective layer 12 is placed around the peripheral of the bump structure 110. On the surface of polarizing layer 13, a first alignment film 14 is then formed to cover the bump structure 1 10.

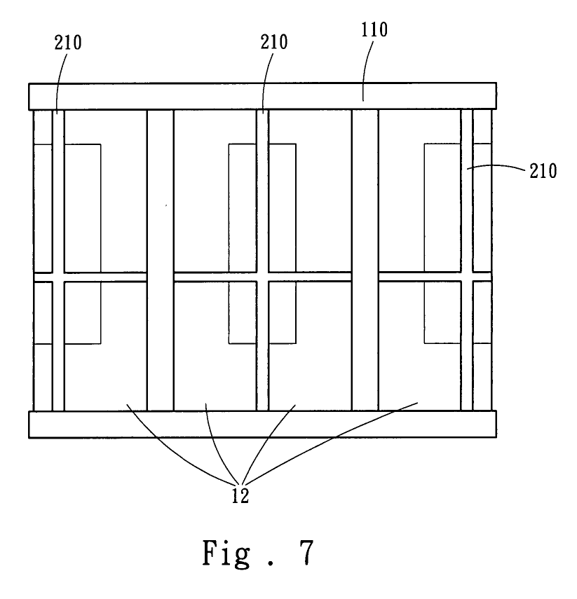

A second substrate 20 contains a color filter. An upper electrode 21 is installed on the second substrate 20. A polarizer film 23 is placed at the outer region of the second substrate 20. The transmission axis of the polarizer film 23 is normal to the polarizing layer 13. The upper electrode 21 contains a figure of bump structure 210 which contains at least one dot-like bump. Then a second alignment film 24 is formed to cover the upper electrode 21 and the bump structure 210. However, the figure of bump structure 210 of the upper electrode 21 is arranged so that it does not overlay the figure of bump structure 110 of pixel electrode 11 in the perpendicular direction. The figures of bump structures 110 and 210 fabricated within a single pixel are shown in FIG. 7. A liquid crystal cell 30 is formed and is installed between the first alignment film 14 and the second alignment film 24.

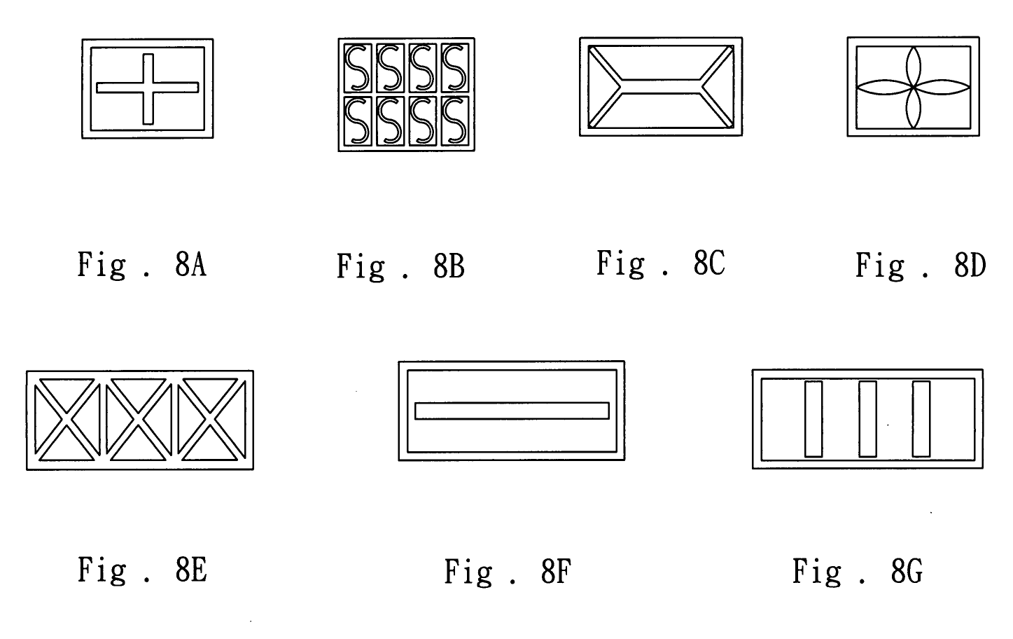

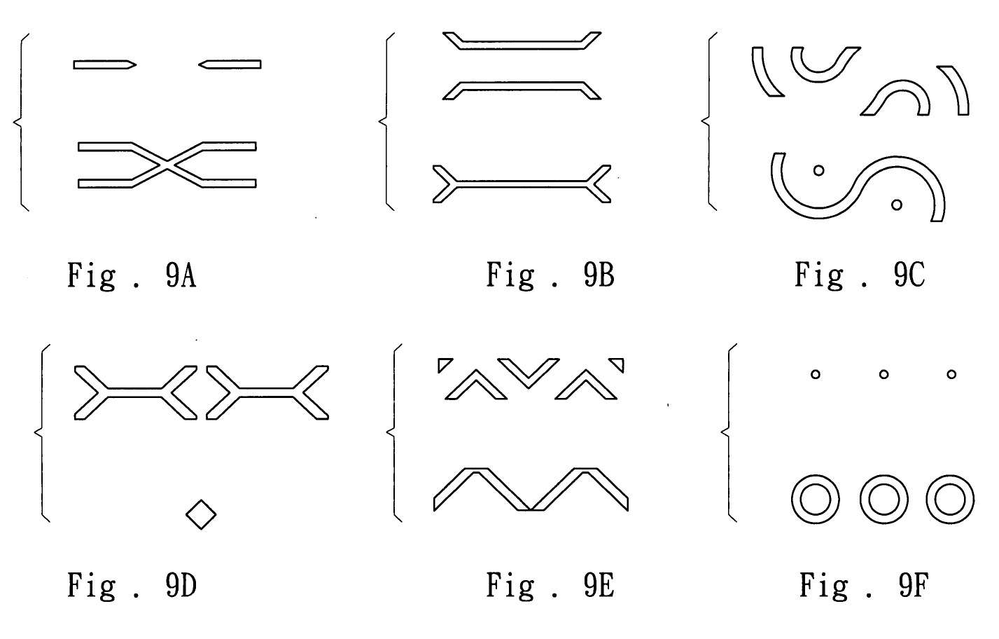

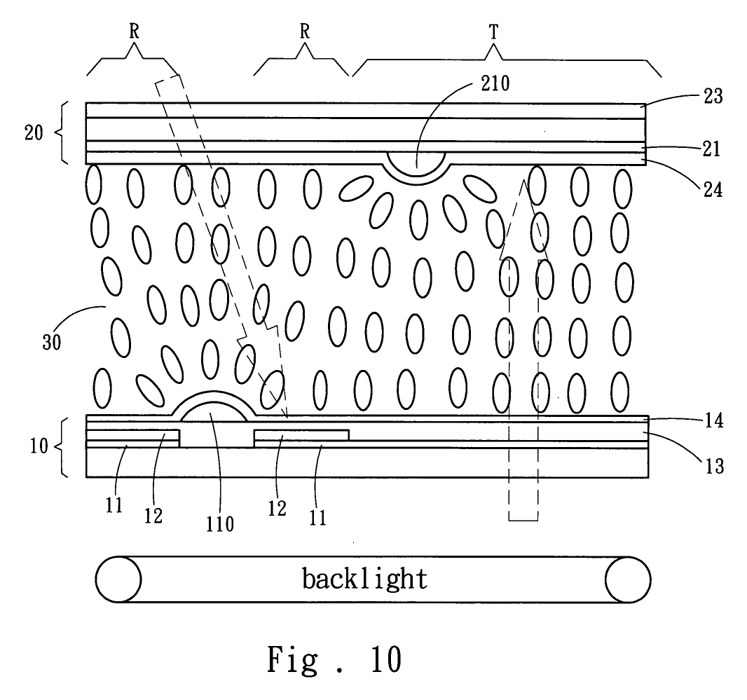

There are two portions of the statement of the invention, namely the wide view angle and the reflective function. The wide view angle is achieved through the arrangements of figures of bump structure 110 on the first substrate 10 and figures of bump structure 210 of the upper electrode 21 on the second substrate 20. Adjusting the relative positions of bump structures 110 and 210 provide the liquid crystal molecules in liquid crystal cell 30 with pre-tilt angles and controlled directions of tilt, forming a vertical alignment with multi-domain division and wide view angle. The figures of bump structures 110 and 210 could be a combination of crucifix shape, herringbone shape, X-shape, S-shape, flower petal shape, horizontal configuration or vertical slot shape etc., as shown in FIGS. 8A˜8G and FIGS. 9A˜9F.

The reflective function is achieved through the formation of the reflective zone R of the reflective layer 12 around the peripheral of the figure of bump structure 110, to provide external light source with reflection. The light in both reflective and transmissive zones has the same direction of polarization while passing through the polarizer film 23 and the liquid crystal cell 30. This is how semi-transmissive and semi-reflective effect is achieved.

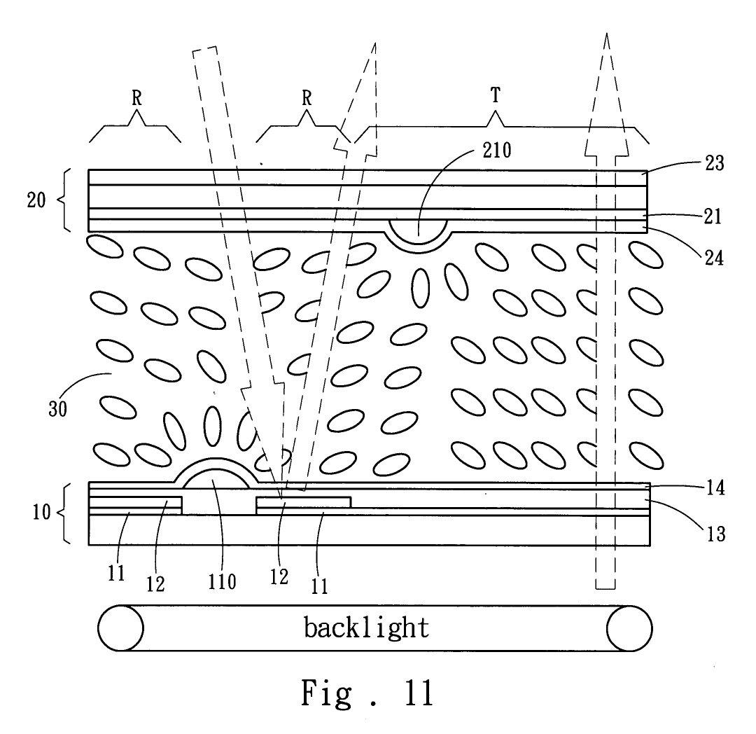

Prior to the application of driving voltage, the long axis of liquid crystal molecules in liquid crystal cell 30 at the transmissive zone T is vertical to the second substrate 20 as well as the first substrate 10 at the top and the bottom respectively, as shown in FIG. 10. The backlight at the bottom passes through the polarizing layer 13, penetrates the liquid crystal cell 30, and reaches the second substrate 20, forming a linear polarized light at an angle of 90 degrees with respect to polarize direction of the polarizer film 23 on the second substrate 20, therefore the light is blocked and the image is dark. On the reflective zone R, the long axis of liquid crystal molecules within the liquid crystal cell 30 is also vertical to the second substrate 20 and the first substrate 10 at the top and the bottom respectively. The external light passes through the polarizer film 23, penetrates the liquid crystal cell 30, forming an angle of 90 degrees with the polarize direction of the polarizing layer 13 on the first substrate 10, therefore the light is absorbed and the image is dark.

As shown in FIG. 11, when the driving voltage is applied to liquid crystals at the transmissive zone T, the liquid crystal molecules within the liquid crystal cell 30 will experience a marginal electric field and tilt toward the peripheral of bump structure 110, and the peripheral of bump structure 210 at the top of upper electrode 21. The angle between the long axis of liquid crystal molecules and direction of the applied voltage will be at 90 degrees. The backlight at the bottom passes through the polarizing layer 13 forming a linear polarized light, penetrates the liquid crystal cell 30, the polarization direction of the polarized light is not perpendicular to the polarization axis of the polarizer film 23 on the second substrate 20, so that the light passes through to produce a bright frame. On the reflective zone R, liquid crystal molecules within the liquid crystal cell 30 will tilt toward the peripherals of bump structures 110 and 210. The angle between the long axis of liquid crystal molecules and the direction of applied voltage will be at 90 degrees. The external light passes through the polarizer film 23 on the second substrate 20 (and the liquid crystal cell 30), the polarization direction of the polarized light is not perpendicular to the polarization axis of the polarizing layer 13 on the first substrate 10. The outside light is reflected by the reflection layer 12 and passes through the LC cells 30, and the polarization direction of the reflection light is not perpendicular to the polarization axis of the polarizer film 23 on the second substrate 20. The reflection light passes to produce a bright frame.

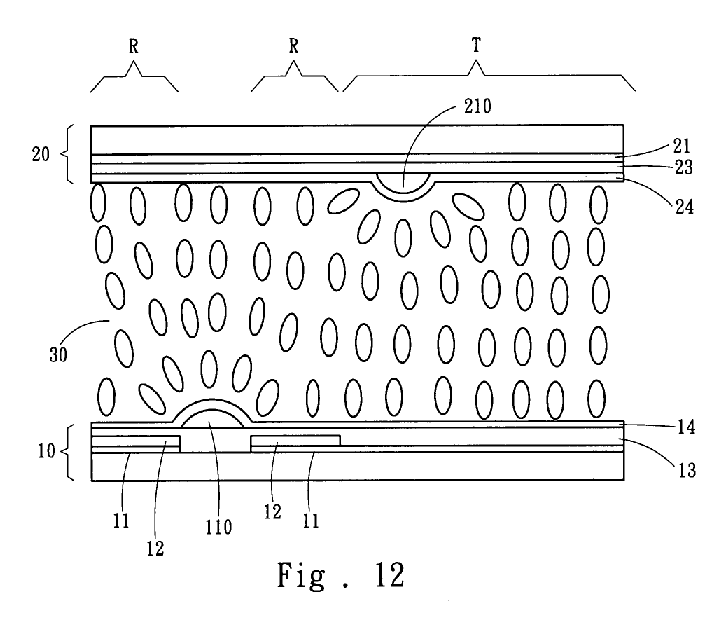

The second schematic diagram of the structure of liquid crystal display in the present invention is shown in FIG. 12. The difference between FIG. 6 and FIG. 12 is that the polarizer film 23 can be placed between the second substrate 20 and the upper electrode 21. Similarly, the transmissive axis of polarizer film 13 is normal to the polarizing layer 13.

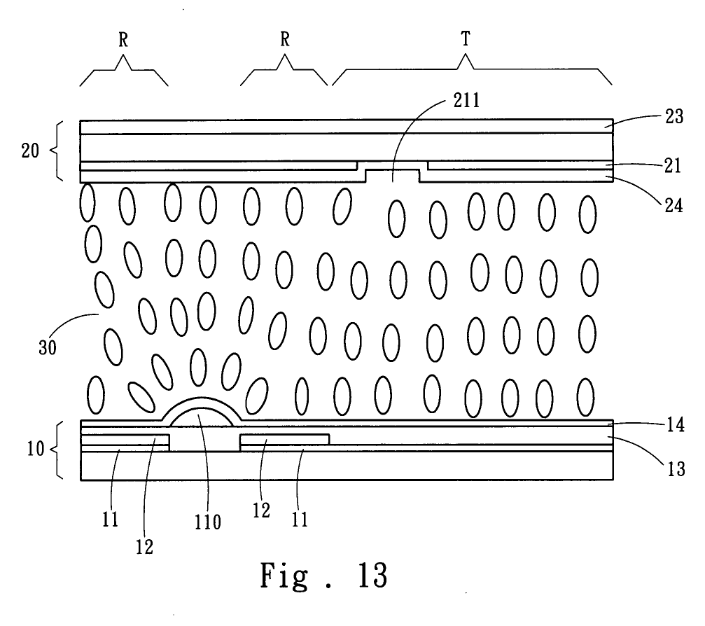

The third schematic diagram of the structure of liquid crystal display in the present invention is shown in FIG. 13. The difference between FIG. 6 and FIG. 13 is that the upper electrode 21 on the second substrate 20 contains a figure of slit structure 211, and the figure of slit structure 211 on the upper electrode 21 within each pixel contains at least one dot-like slit. Then a second alignment film 24 is formed to cover the upper electrode 21 and the slit structures 211. The figure of slit structure 211 on the upper electrode 21 is arranged so that it does not overlay the figure of bump structure 110 of pixel electrode 11 in the perpendicular direction. The figures of bump structures and the slit structures are shown in FIGS. 8A˜8G and FIGS. 9A˜9F.

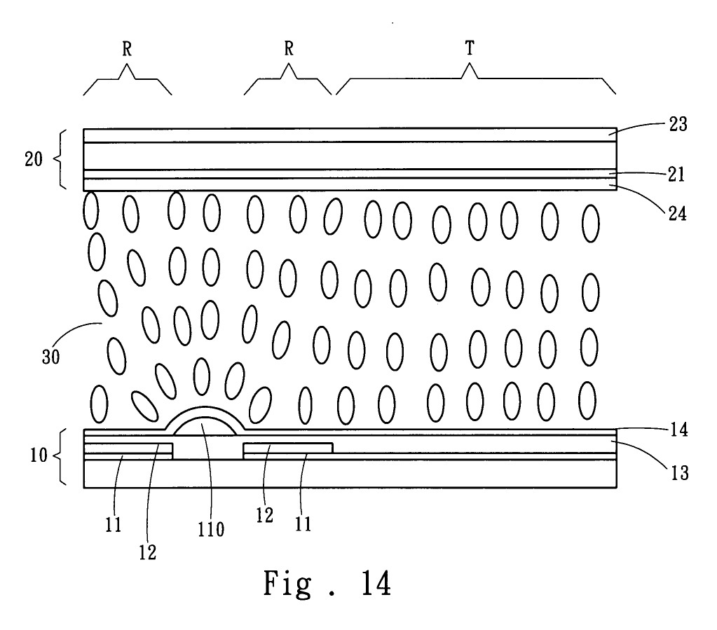

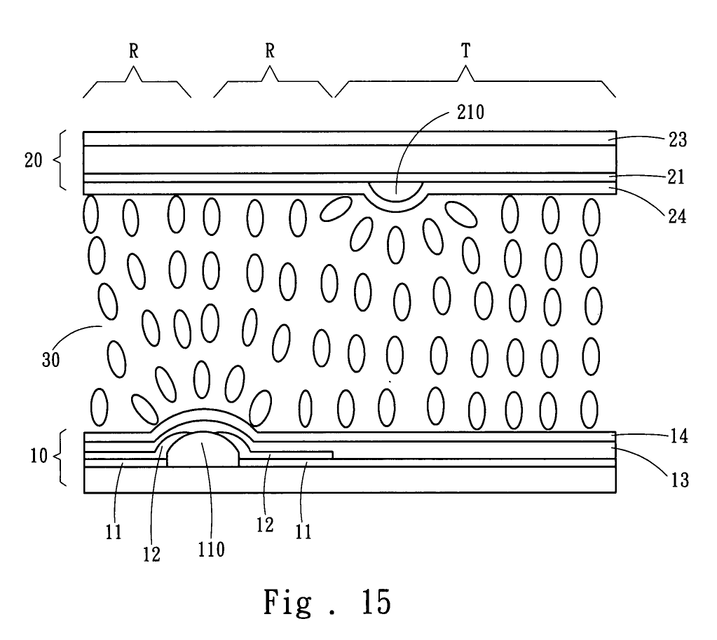

The upper electrode 21 on the second substrate 20 can certainly be a flat plane where the second alignment film 24 covers directly on the top of upper electrode 21, as shown in FIG. 14. Finally a liquid crystal cell 30 is installed between the first substrate 10 and the second substrate 20.

The fifth schematic diagram of the structure of liquid crystal display in the present invention is shown in FIG. 15. The other type of structure in the present invention is to firstly define the pixel electrode 11 on the first substrate 10, then define a pattern of bump structure 110 on it by using photolithography processes, and then define the reflective zone R by forming the reflective layer 12 to cover part of the slope region on the bump structure 110 and the pixel electrode 11. The polarizing layer 13 is then formed to cover the pattern of bump structure 110, the reflective layer 12 and the pixel electrode 11. Finally, the first alignment film 14 is then formed on the surface of polarizing layer 13. The first side of substrate 10 is done.

The second substrate is shown in FIG. 6, the first schematic diagram of the structure of liquid crystal display in the present invention. The upper electrode 21 on the second substrate 20 contains the figure of bump structure 210. The second alignment film 24 is then formed to cover the upper electrode 21 and the bump structures 210. The bump structure 210 on the upper electrode 21 is arranged so that it does not overlay the figure of bump structure 110 of pixel electrode 11 in the perpendicular direction. The figures of bump structure 110 and 210 can be a combination of crucifix shape, herringbone shape, X-shape, S-shape, flower petal shape, horizontal configuration or vertical slot shape etc., as shown in FIGS. 8A˜8G and FIGS. 9A˜9F. The polarizer film 23 with its normal to the polarizing layer 13 can be placed either at the outer surface of the second substrate 20 or between the second substrate 20 and the upper electrode 21.

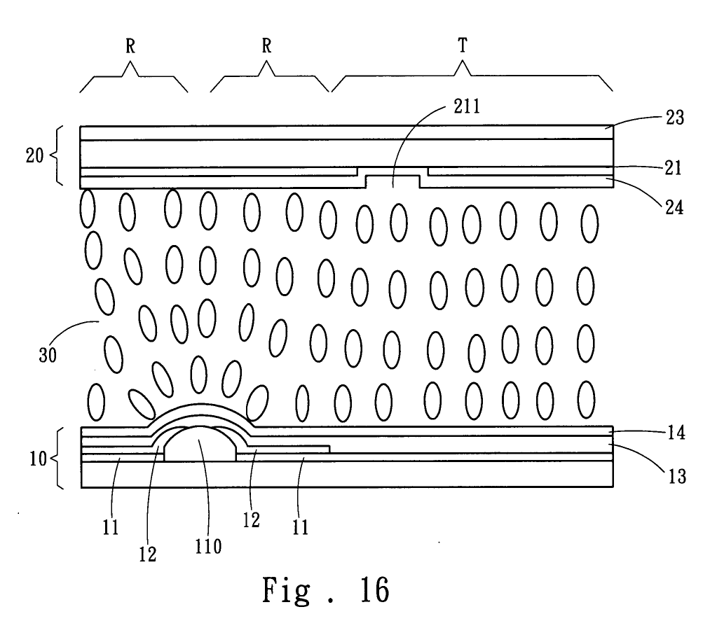

The sixth schematic diagram of the structure of liquid crystal display in the present invention is shown in FIG. 16. The difference between FIG. 16 and FIG. 15 is that the upper electrode 21 on the second substrate 20 may contain a figure of slit structure 211, and the figure of slit structure 211 on the upper electrode 21 within each pixel contains at least one dot-like slit. Then the second alignment film 24 is formed to cover the upper electrode 21 and the slit structures 211. The figure of slit structure 211 on the upper electrode 21 is arranged so that it does not overlay the figure of bump structure 110 of pixel electrode 11 in the perpendicular direction. The figures of bump structures 110 and 210 are shown in FIGS. 8A˜8G and FIGS. 9A˜9F as described before.

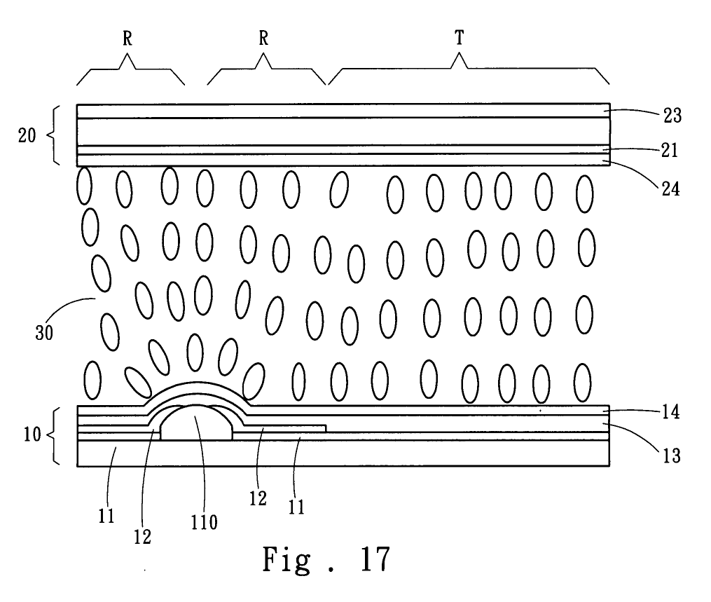

The upper electrode 21 on the second substrate 20 can certainly be a flat plane with the second alignment film 24 covering directly on the top of it, as shown in FIG. 17. Finally the liquid crystal cell 30 is installed between the first substrate 10 and the second substrate 20.

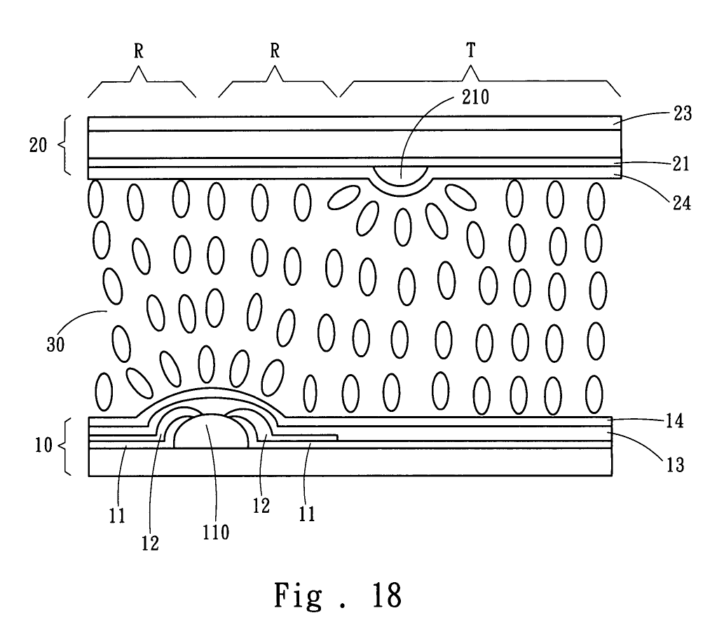

The eighth schematic diagram of the structure of liquid crystal display in the present invention is shown in FIG. 18. Still another type of structure in the present invention first defines the figure of bump structure 110 on the first substrate 10 by using photolithography processes, then deposits a figure of pixel electrode 11, and then deposit the reflective layer 12 to cover part of the slope region on the bump structure 110 and the pixel electrode 11 to define the reflective zone R and the transmissive zone T. The polarizing layer 13 is then formed to cover the pattern of bump structure 110, the reflective layer 12 and the pixel electrode 11. Finally, the first alignment film 14 is formed on the surface of polarizing layer 13. The first side of substrate 10 is done. Compared with FIGS. 15 to 17, the area of the pixel electrode 11 on the bump structure 110, and hence the aperture ratio can be increased this scheme.

The second substrate is shown in FIG. 6, the first schematic diagram of the structure of liquid crystal display in the present invention. The upper electrode 21 on the second substrate 20 contains a figure of bump structure 211. The second alignment film 24 is formed to cover the upper electrode 21 and the bump structures 210. The polarizer film 23 with transmission axis normal to the polarizing layer 13 can be placed either at the outer surface of the second substrate 20 or between the second substrate 20 and the upper electrode 21. The bump structure 210 on the upper electrode 21 is arranged so that it does not overlay the figure of bump structure 110 of pixel electrode 11 in the perpendicular direction. The figures of bump structures 110 and 210 can be a combination of crucifix shape, herringbone shape, X-shape, S-shape, flower petal shape, horizontal configuration or vertical slot shape etc., as shown in FIGS. 8A˜8G and FIGS. 9A˜9F.

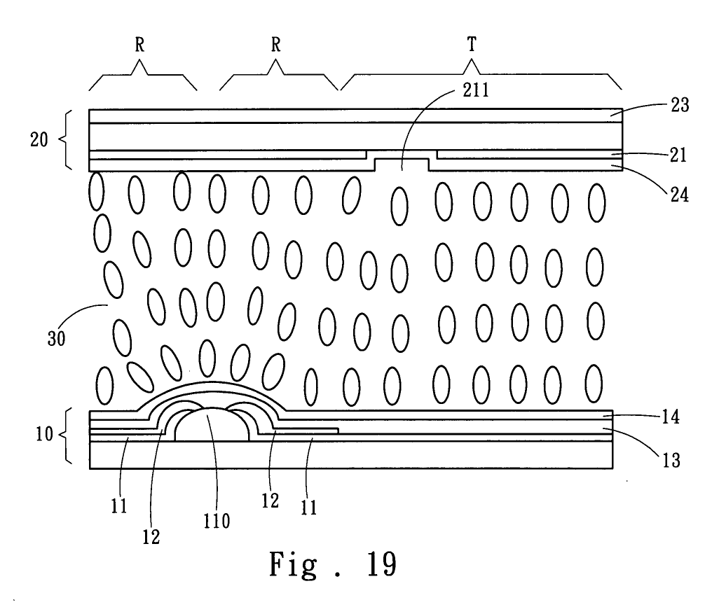

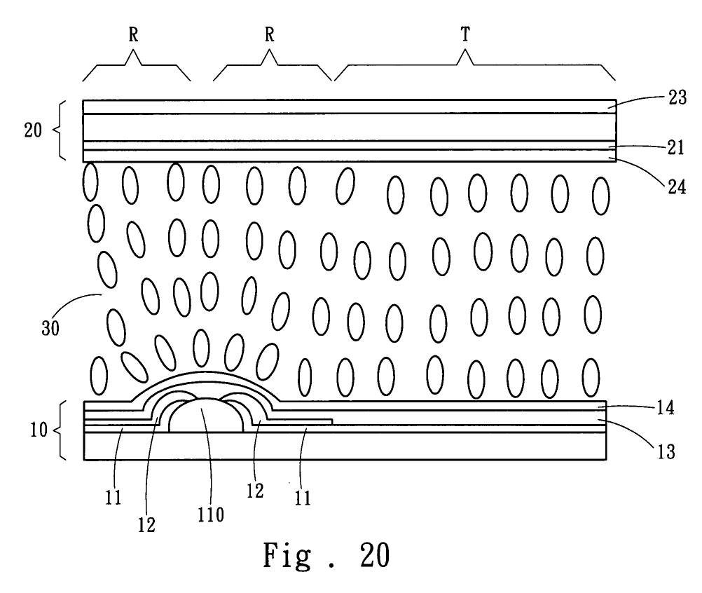

The ninth schematic diagram of the structure of liquid crystal display in the present invention is shown in FIG. 19. The difference between FIG. 18 and FIG. 19 is that the upper electrode 21 on the second substrate 20 contains a figure of slit structure 211, and the figure of slit structure 211 on the upper electrode 21 within each pixel contains at least one dot-like slit. Then the second alignment film 24 is formed to cover the upper electrode 21 and the slit structures 211. The figure of slit structure 211 on the upper electrode 21 is arranged so that it does not overlay the figure of bump structure 110 of pixel electrode 11 in the perpendicular direction. The figures of bump structures 110 and 210 are shown in FIGS. 8A˜8G and FIGS. 9A˜9F as described before.

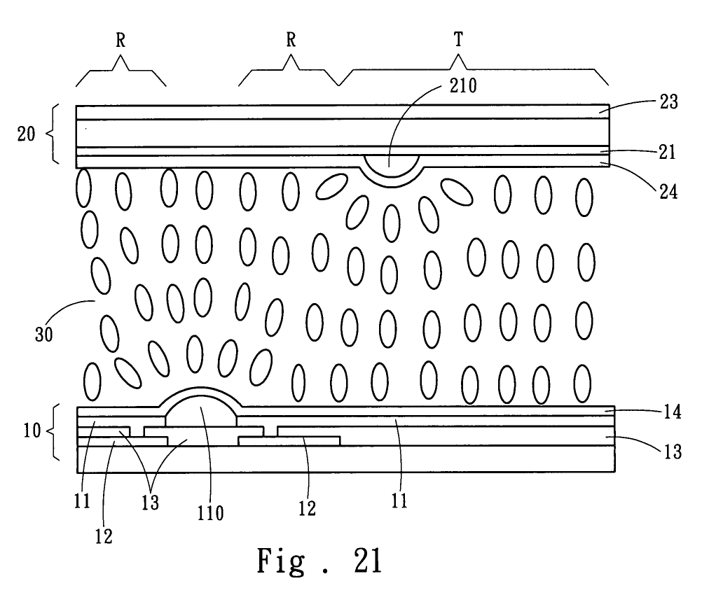

The upper electrode 21 on the second substrate 20 can certainly be a flat plane with the second alignment film 24 covering directly on the top of it, as shown in FIG. 20. Finally a liquid crystal cell 30 is installed between the first substrate 10 and the second substrate 20.

The eleventh schematic diagram of the structure of liquid crystal display in the present invention is shown in FIG. 21. Still another type of structure in the present invention first deposit a reflective layer 12 on first substrate 10 to define the reflective zone R and the transmissive zone T. A polarizing layer 13 covering reflective layer 12 is then formed on the surface of first substrate 10. And then the figure of pixel electrode 11 is defined and formed by deposition. At least one contact window is excavated on the polarizing layer 13 to expose the surface of reflective layer 12 to ensure electrical contact between the reflective layer 12 and the pixel electrode 11. A figure of bump structure 110 is then defined on the figure of pixel electrode 11 by using photolithography processes. Finally, the first alignment film 14 is formed on the surface of the figure of pixel electrode 11. The first side of substrate 10 is done.

The second substrate 20 is shown in FIG. 6, the first schematic diagram of the structure of liquid crystal display in the present invention. The upper electrode 21 on the second substrate 20 contains a figure of bump structure 210. The second alignment film 24 is formed to cover the upper electrode 21 and the bump structures 210. Similarly, the polarizer film 23 can be placed either at the outer surface of the second substrate 20 or between the second substrate 20 and the upper electrode 21, and the transmissive axis of polarizer film 23 is normal to the polarizing layer 13. The bump structure 210 on the upper electrode 21 is arranged so that it does not overlay the figure of bump structure 110 of pixel electrode 11 in the perpendicular direction. The figures of bump structures 110 and 210 could be a combination of crucifix shape, herringbone shape, X-shape, S-shape, flower petal shape, horizontal configuration or vertical slot shape etc., as shown in FIGS. 8A˜8G and FIGS. 9A˜9F.

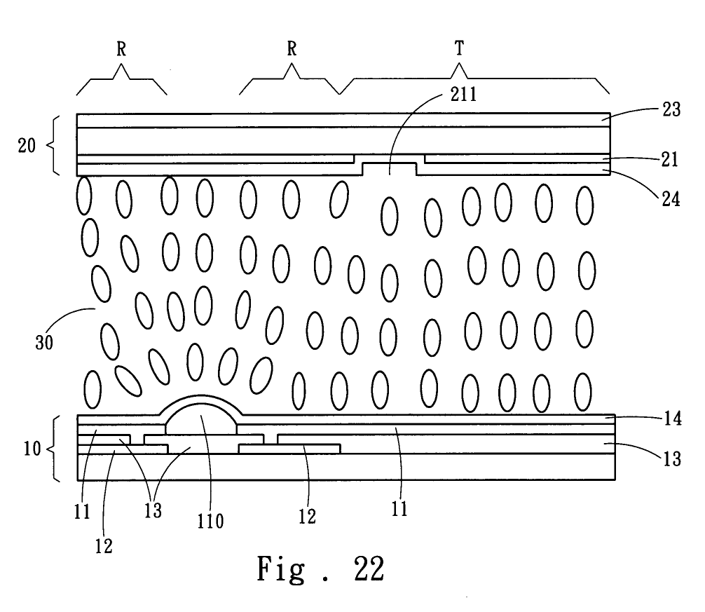

The twelfth schematic diagram of the structure of liquid crystal display in the present invention is shown in FIG. 22. The difference between FIG. 21 and FIG. 22 is that the upper electrode 21 on the second substrate 20 may contain a figure of slit structure 211. The figure of slit structure 211 on the upper electrode 21 within each pixel contains at least one dot-like slit. The second alignment film 24 is formed to cover the upper electrode 21 and the slit structures 211. The figure of slit structure 211 on the upper electrode 21 is arranged so that it does not overlay the figure of bump structure 110 of pixel electrode 11 in the perpendicular direction. The figures of bump structures 110 and 210 are shown in FIGS. 8A˜8G and FIGS. 9A˜9F as described before.

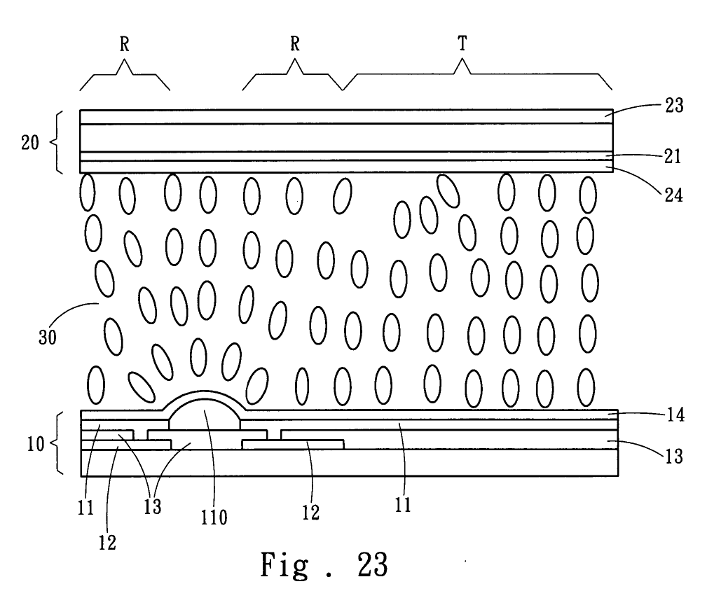

The upper electrode 21 on the second substrate 20 can certainly be a flat plane with the second alignment film 24 covering directly on the top of it, as shown in FIG. 23. Finally a liquid crystal cell 30 is installed between the first substrate 10 and the second substrate 20.

In summary, the present invention aimed at defining transmissive zones and reflective zones on pixel electrodes under the structure of wide view angle function to provide a wide view angle liquid crystal display with reflective effects. The relative positions of slit/bump structures between electrodes provide the liquid crystal molecules with pre-tilt angles and a controlled direction of tilt, forming a multi-domain division alignment. Meanwhile, the reflective zone and the transmissive zone form a transflective liquid crystal display device. Compared with the known technologies, the liquid crystal display in the present invention accomplish the effect of wide view angle and, at the same time, take full advantage of lights from both transmissive and reflective zones. Therefore excellent clear image both indoors and outdoors and reduction of power consumption can be achieved.

However, what described above should simply be deemed better examples of the present invention, not as a limitation to its range of implementation. All proportional variations or modifications based on the range claimed in this patent are covered by the present invention patent.

What is claimed is:

1. A reflective and transflective liquid crystal display and a structure of each pixel comprising:
a first substrate which has a pixel electrode with a bump structure at its top on the surface of the first substrate;
a reflective layer which is placed around the peripheral of a bump structure and covers part of the pixel electrode;
a polarizing layer which covers the reflective layer and the pixel electrode;
a first alignment film which covers the polarizing layer;
a second substrate which has an upper electrode placed on the surface of it facing the first substrate;
a second alignment film which covers the upper electrode; and
a liquid crystal cell which is installed between the first alignment film and the second alignment film.

2. The reflective and transflective liquid crystal display and a structure of each pixel as claimed in claim 1, wherein a polarizer film is deposited on the surface of the second substrate with its transmission axis normal to the polarizing layer.

3. The reflective and transflective liquid crystal display and a structure of each pixel as claimed in claim 1, wherein the first substrate contains at least one thin film transistor.

4. The reflective and transflective liquid crystal display and a structure of each pixel as claimed in claim 1, wherein the second substrate contains a color filter.

5. The reflective and transflective liquid crystal display and a structure of each pixel as claimed in claim 1, wherein the bump structure of each pixel contains at least one dot-like bump.

6. The reflective and transflective liquid crystal display and a structure of each pixel as claimed in claim 1, wherein the reflective layer is made of metallic materials with low resistance and high reflectivity.

7. The reflective and transflective liquid crystal display and a structure of each pixel as claimed in claim 1, wherein the upper electrode contains a slit structure.

8. The reflective and transflective liquid crystal display and a structure of each pixel as claimed in claim 7, wherein the slit structure contains at least one dot-like slit

9. The reflective and transflective liquid crystal display and a structure of each pixel as claimed in claim 7, wherein the slit structure on the upper electrode is arranged so that it does not overlay the bump structure of pixel electrode in the perpendicular direction.

10. The reflective and transflective liquid crystal display and a structure of each pixel as claimed in claim 1, wherein the upper electrode contains a bump structure.

11. The reflective and transflective liquid crystal display and a structure of each pixel as claimed in claim 10, wherein the bump structure on the upper electrode contains at least one dot-like bump.

12. The reflective and transflective liquid crystal display and a structure of each pixel as claimed in claim 10, wherein the bump structure on the upper electrode is arranged so that it does not overlay the bump structure of pixel electrode in the perpendicular direction.
